(19) United States
(12) Patent Application Publication
(10) Pub. No.: US 2010/0063834 A1
(43) Pub. Date: Mar. 11, 2010

(54) Medical Communication System

(76) Inventor: Santosh Mukherjee, Bloomfield, NJ (US)

Correspondence Address: Ashok Tankha, 36 Greenleigh Drive, Sewell, NJ, 08080, US

(21) Appl. No.: 12/206,744

(22) Filed: Sep. 9, 2008

(51) Int. Cl. G06Q 50/00

(52) U.S. Cl. 705/2

(57) ABSTRACT

Disclosed herein is a method and system for integrating and controlling multiple medical electronic devices. A medical communication system is provided for communicating with and controlling the medical electronic devices. A communication link is established between the medical communication system and the medical electronic devices. The medical communication system selects one or more medical electronic device based on diagnostic requirements. The selected medical electronic devices are configured using a set of configuration parameters. The medical data is then captured by the medical electronic devices. The captured medical data is transferred to the medical communication system via the communication link. The medical communication system stores the transferred medical data for medical diagnosis. A medical report may be generated based on the medical data received. The concerned doctor, physician, or caretaker may be notified about the availability of the medical data and the generated medical report.

### BACKGROUND

This invention, in general, relates to capture of medical information from medical electronic devices. More particularly, this invention relates to integrating and controlling multiple medical electronic devices to obtain medical information automatically.

Medical electronic devices include diagnostic devices, therapeutic devices, life support devices, medical laboratory devices, and medical monitoring devices. Currently, most of the medical electronic devices are used as standalone devices. Typically, a physician prescribes a set of medical tests for a patient. The patient then undergoes the tests at different sections of a medical laboratory or diagnostic center depending on the nature of the tests to be performed. During conduction of these medical tests, multiple medical devices may be used to capture medical data. The medical data captured by each of these medical devices is used by the physicians for providing medical treatment to the patient. The capture of medical data may be cumbersome for a lab physician, since the lab physician has to individually program and control each of the medical devices to perform the necessary medical tests on the patient. Further, the physician or the doctor has to review the medical data collected separately from each of the medical devices. The physician may not have the complete medical data for effective diagnosis of the patient's health condition at the required time. Therefore, there is a need for integrating and controlling the medical electronic devices in order to perform medical tests on a patient without having to operate each of the medical devices separately.

Hence there is an unmet need for a method and system that integrates and controls medical electronic devices for capturing medical data of a patient.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated need for integrating and controlling multiple medical electronic devices utilizing a medical communication system.

A medical communication system is provided for communicating with and controlling the medical electronic devices. The medical electronic devices comprise, for example, diagnostic devices, therapeutic devices, life support devices, medical laboratory devices, and medical monitoring devices. The medical electronic devices are used to capture medical data. A communication link is established between the medical communication system and the medical electronic devices. The communication between the medical devices may occur via a wired network using technologies, for example, Ethernet. The network may also be a wireless network such as wireless fidelity, worldwide interoperability for microwave access, a wireless grid, the internet, etc.

The medical communication system selects at least one of the medical electronic devices based on diagnostic requirements. The medical communication system sets configuration parameters for the selected medical electronic devices. The medical communication system configures the selected medical electronic devices via the communication link based on the configuration parameters. The selected medical electronic devices capture the medical data. The medical data comprises, for example, information from the medical electronic devices, diagnostic information, therapeutic information, status of the life support devices, results from medical laboratory devices, and information from medical monitoring devices.

The captured medical data is then transferred to the medical communication system via the communication link. The medical communication system stores the transferred medical data for medical diagnosis. The transferred medical data is analyzed to automatically generate recommendations on medical procedures to be performed in medical cases by a doctor, a physician, or a caretaker. A medical report is then generated based on the analysis of the transferred medical data. The medical report comprises the recommendations on the medical procedures to be performed in medical cases by the doctor, the physician, or the caretaker. The medical report generated by the doctor, the physician, or the caretaker based on a medical diagnosis may be compared with the medical report generated by the medical communication system. The concerned doctor, physician, or caretaker may then be notified about the availability of the medical data and the generated medical report.

The goals of integrating and controlling the medical electronic devices are provided by the medical communication system in order to standardize the entire process of diagnosis, thereby making the process of diagnosis faster, and minimizing medical diagnostic errors.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of integrating and controlling multiple medical electronic devices.

FIG. 2 illustrates a system for integrating and controlling multiple medical electronic devices.

FIG. 3 exemplarily illustrates a system for remotely controlling medical electronic devices using a web portal.

### DETAILED DESCRIPTION OF THE INVENTION

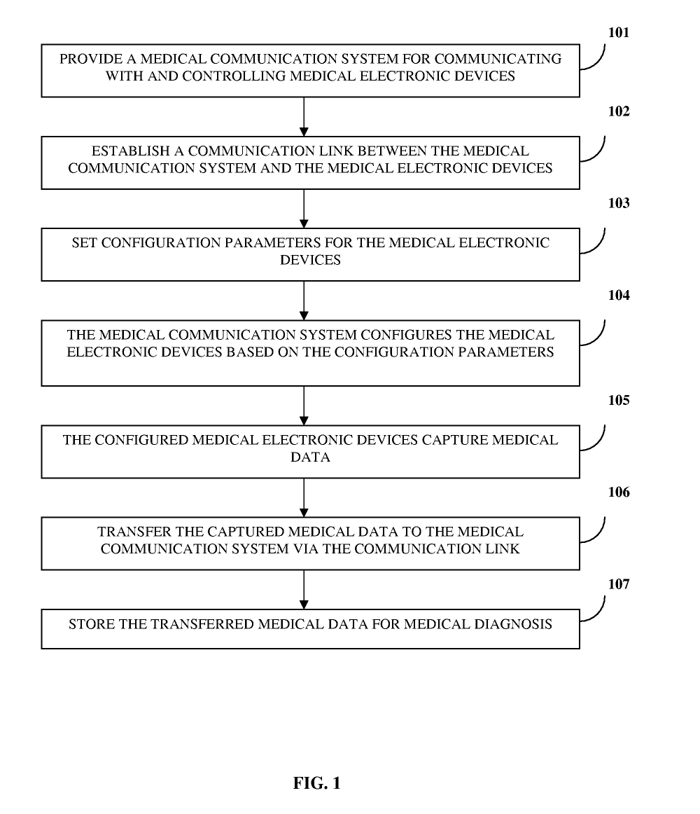

FIG. 1 illustrates a method of integrating and controlling multiple medical electronic devices. The method disclosed herein provides 101 a medical communication system for communicating with and controlling the medical electronic devices. The medical electronic devices are used to capture medical data. These medical electronic devices are connected to each other via a network.

The medical electronic devices comprise, for example, diagnostic devices, therapeutic devices, life support devices, medical laboratory devices, and medical monitoring devices. The diagnostic devices may comprise, for example, ultrasound and Magnetic Resonance Imaging (MRI) machines, Computed Tomography (CT) scanners, X-ray machines etc. The therapeutic devices may comprise, for example, infusion pumps, medical lasers, etc. The life support devices may comprise, for example, medical ventilators, heart-lung machines, dialysis machines etc. The medical monitoring devices measure patient vital signs and other parameters, for example, Electrocardiogram (ECG), Electroencephalography (EEG), blood pressure, dissolved gases in the blood, etc. Medical laboratory devices are used to analyze blood, urine, genes etc. A communication link is established 102 between the medical communication system and the medical electronic devices. The communication link may be a wired or a wireless link. The communication between the medical electronic devices takes place using wired technologies, for example Ethernet. The communication may also take place using wireless technologies, for example wireless fidelity, worldwide interoperability for microwave access, a wireless grid, etc.

The medical communication system selects at least one of the medical electronic devices to capture medical data based on diagnostic requirements. The medical communication system sets 103 configuration parameters for the selected medical electronic devices. The medical communication system stores the configuration parameter settings of the medical electronic devices. The medical communication system configures 104 the medical electronic devices via the communication link based on the configuration parameters. The configuration parameters comprise device settings and control parameters of the medical electronic devices. For example, the medical communication system selects device protocols to establish communication between the medical electronic devices and the medical communication system. The configuration parameters further comprise medical electronic device related configuration parameters and medical case related configuration parameters.

Consider an example where a patient needs to undergo mechanical ventilation using medical ventilators. The medical communication system configures the medical ventilator based on the configuration parameters. The device settings in case of the medical ventilator comprise, for example, settings for air pressure, oxygen content, and volume flow. The control parameters in case of the medical ventilator comprise, for example, parameters for air pressure variation for passive inhalation and exhalation of the patient, oxygen content from ambient air to pure oxygen, and volume flow characteristics.

The medical electronic device is configured to a preset mode. The preset mode comprises predetermined configuration parameters and device settings. The configuration parameters for the preset mode of the medical electronic devices are stored in the medical communication system. The preset mode data may be used in future medical cases involving the same medical electronic device. Consider an example of a pulse oximeter used for analyzing the oxygen content of blood. The pulse oximeter is set to a preset mode. The preset mode in case of the pulse oximeter involves setting the Light Emitting Diode (LED) to a predefined wavelength.

The medical communication system initiates the capture 105 of the medical data using the configured medical electronic devices. The medical data may comprise, for example, information from the medical electronic devices, diagnostic information, therapeutic information, status on the life support devices, results from medical laboratory devices, and information from medical monitoring devices. The step of capturing the medical data is initiated by a timer based trigger, an event based trigger, or a combination thereof. An event based trigger initiates capturing of the medical data by the medical electronic devices on occurrence of an external medical event. A timer based trigger initiates capturing of the medical data by the medical electronic devices based on predefined time settings. The medical communication system also schedules the time and sequence of capture of the medical data by the medical electronic devices.

The configured medical electronic devices then capture 105 the medical data. The captured medical data is transferred 106 to the medical communication system via the communication link. The medical communication system converts the transferred medical data into a text file, a video file, or an image file. The medical communication system analyzes the transferred medical data and automatically generates recommendations on medical procedures to be performed in medical cases by a doctor, a physician, or a caretaker. The medical communication system generates a medical report based on the analysis of the transferred medical data. The medical report comprises the recommendations on the medical procedures to be performed in medical cases by a doctor, a physician, or a caretaker.

A medical report may be generated by the concerned doctor, physician, or caretaker based on medical diagnosis. The medical report generated by the concerned doctor, physician, or caretaker is compared with the medical report generated by the medical communication system. The concerned doctor, physician, or caretaker makes an assessment on the medical condition based on the compared medical reports. The comparison enables the achievement of an accurate medical diagnosis.

The medical communication system then notifies the concerned doctor, physician, caretaker, etc. by sending a notification. The notification comprises alerts for extreme medical conditions, availability of the medical data, and a generated medical report. The notification may be sent via electronic means, for example, an electronic mail (email), short message service (SMS), or a text message. The doctor, physician, or caretaker checks for the authenticity of the medical report and performs the recommended medical procedures at their own discretion. The medical communication system stores 107 the transferred medical data for medical diagnosis.

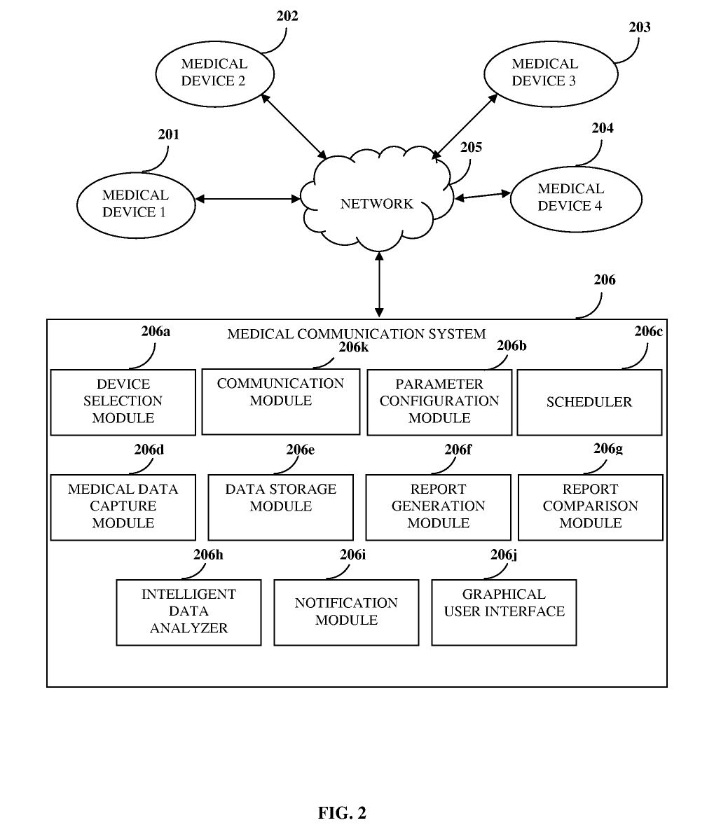

FIG. 2 illustrates a system for integrating and controlling multiple medical electronic devices. The system disclosed herein comprises multiple medical electronic devices and a medical communication system 206 connected via a network 205. The medical electronic devices, for example, medical device 1 201, medical device 2 202, medical device 3 203, and medical device 4 204 are illustrated in FIG. 2. The medical electronic devices are connected to each other via a network 205. The medical communication system 206 is in communication with the multiple medical electronic devices. The medical communication system 206 communicates with and controls the medical electronic devices. The medical communication system 206 comprises a device selection module 206a, a communication module 206k, a parameter configuration module 206b, a scheduler 206c, a medical data capture module 206d, a data storage module 206e, a report generation module 206f, a report comparison module 206g, an intelligent data analyzer 206h, a notification module 206i, and a graphical user interface (GUI) 206j.

The device selection module 206a selects at least one of the medical electronic devices to capture medical data based on the diagnostic requirements. The communication module 206k establishes a communication link between the medical communication system 206 and the selected medical electronic devices. The parameter configuration module 206b configures the selected medical electronic devices using a set of configuration parameters via the communication link. The configuration parameters comprise device settings and control parameters of the medical electronic devices. The data storage module 206e stores the configuration parameter settings of the selected medical electronic devices. The data storage module 206e may be located in a remote location to enable a physician, doctor, or a caretaker to monitor, assess, and diagnose a patient remotely. The configured medical electronic devices, for example, the medical device 1 201, the medical device 2 202, the medical device 3 203, and the medical device 4 204 capture the medical data. The scheduler 206c schedules the time and sequence of the medical data capture by the medical electronic devices. The configured medical electronic devices capture medical data, for example, diagnostic information, therapeutic information, status on the life support devices, results from medical laboratory devices, and information from medical monitoring devices.

The medical electronic devices transfer the captured medical data to the medical communication system 206. The medical data capture module 206d captures the transferred medical data. The data storage module 206e stores the transferred medical data in the medical communication system 206. The GUI 206j is used to view the medical data captured by one or more of the medical electronic devices and alter the configuration parameters of the medical electronic devices.

The intelligent data analyzer 206h analyzes the transferred medical data to automatically generate recommendations on medical procedures to be performed in medical cases by a doctor, a physician, or a caretaker. The report generation module 206f generates a medical report based on the analysis of the transferred medical data. The medical report comprises the recommendations on the medical procedures to be performed in medical cases by a doctor, a physician, or a caretaker. The notification module 206i sends a notification to the concerned doctor, physician, or caretaker, etc. about the availability of the medical data and the generated medical report. The notification is sent to a remotely located doctor, physician, or caretaker. The notification module 206i sends the notification via electronic means, for example, an email, an SMS message, and a text message. The notification module 206i also alerts the concerned doctor, physician, or caretaker etc. in case of medical emergency. Consider an example where a patient needs to undergo mechanical ventilation using medical ventilators. The notification module 206i of the medical communication system 206 alerts the concerned caretaker in emergency cases, for example, power failure, defective gas, and software failure. The doctor, physician, or caretaker checks for the authenticity of the medical report and performs the recommended medical procedures at their own discretion.

A medical report may also be generated by the concerned doctor, physician or caretaker based on medical diagnosis. The report comparison module 206g compares the medical report generated by the concerned doctor, physician, or caretaker with the medical report generated by the medical communication system 206. The concerned doctor, physician, or caretaker makes an assessment on the medical condition based on the compared medical reports. The comparison enables the achievement of an accurate medical diagnosis.

Consider an example where a physician prescribes a Magnetic Resonance Imaging (MRI) scan for a patient. An MRI machine is in communication with the medical communication system 206. The steps performed by the medical communication system 206 comprise, selecting the medical electronic device, in this case an MRI machine. The parameter configuration module 206b of the medical communication system 206 configures the MRI machine based on a set of configuration parameters. The test is performed by a radiologist. The patient is made to lie still on a narrow table for undergoing the MRI scan.

The scheduler 206c schedules the time and sequence of the image capture by the MRI machine. The images are captured and displayed on a monitor. The captured images are recorded on a magnetic tape recorder and copies of the images are transferred to the medical communication system 206. The medical data capture module 206d captures the image data. The data storage module 206e stores the image data received for medical diagnosis by a physician. The report generation module 206f generates a medical report after interpretation of the images by the radiologist. The notification module 206i notifies the physician about the availability of the medical report. The concerned physician may be located in remote location. The physician may interpret the medical report and may offer medical advice to a patient, while still being remotely located from the patient. The medical communication system 206 then stores the captured images in a data storage module 206e for further diagnosis. The MRI scan report is a way to generate diagnostic information.

Consider another example where a patient needs to undergo mechanical ventilation using a medical ventilator. The medical ventilator is in communication with the medical communication system 206. In case of mechanical ventilation the steps performed by the medical communication system 206 comprise, selecting the medical electronic device, i.e., the medical ventilator. The parameter configuration module 206b of the medical communication system 206 configures medical ventilator based on the configuration parameters. The medical ventilator function related configuration parameters comprise air pressure variation, oxygen content, and flow volume. The scheduler 206c in the medical communication system 206 sets the timing and sequence of passive inhalation and exhalation. The medical ventilator is equipped with a monitoring system and an alerting system to monitor the status of the patient and to alert the concerned caretaker in emergency cases including power failure, defective gas, and software failure. The step of alerting the caretaker is performed by the medical communication system 206. A medical report on the status of the patient is generated on a regular basis. The medical communication system 206 stores the generated medical report in a data storage module 206e for future reference. The notification module 206i notifies the physician about the availability of the medical report.

Consider another example where the vital signs of a patient are to be measured. Vital signs include the objective measures for a patient such as temperature, respiratory rate, pulse rate, and blood pressure. The device selection module 206a in the medical communication system 206 selects the following medical electronic devices, an electronic thermometer to measure temperature, an electronic respiratory rate measuring device for the measurement of respiratory rate, a pulse rate monitor to measure pulse rate, an electronic sphygmomanometer to measure blood pressure.

The electronic thermometer, the electronic respiratory rate measuring device, the pulse rate monitor, and the electronic sphygmomanometer are in communication with the medical communication system 206. The parameter configuration module 206b of the medical communication system 206 configures the selected medical electronic devices using a set of configuration parameters. The scheduler 206c schedules the time and sequence of the medical data capture by the selected medical electronic devices. The intelligent data analyzer module 206h analyzes the captured medical data to automatically generate recommendations on medical procedures to be performed in a medical case by a doctor, a physician, or a caretaker. The report generation module 206f generates a medical report based on the analysis of the captured medical data. The medical report comprises the recommendations on the medical procedures to be performed in medical cases by the concerned physician.

The notification module 206i notifies the concerned physician about the availability of the medical report. The medical communication system 206 then stores the generated medical report for future reference, in a data storage module 206e. The physician checks for the authenticity of the medical report and is at the discretion on performing the recommended medical action. A medical report may also be generated by the physician. The report comparison module 206g compares the medical report generated by the physician with the medical report generated by the medical communication system 206. The concerned doctor, physician, or caretaker makes an assessment on the medical condition based on the compared medical reports. The comparison enables the achievement of an accurate medical diagnosis.

The method and disclosed herein may allow one of a physician, a doctor, and a therapist to control an operation or surgery, anesthesia etc. of a patient in a remote location. The medical communication system 206 may be used to control a sensor based device performing the operation. For example, a surgery may be performed by a sensor based device in India controlled by a surgeon in the United States using the medical communication system 206.

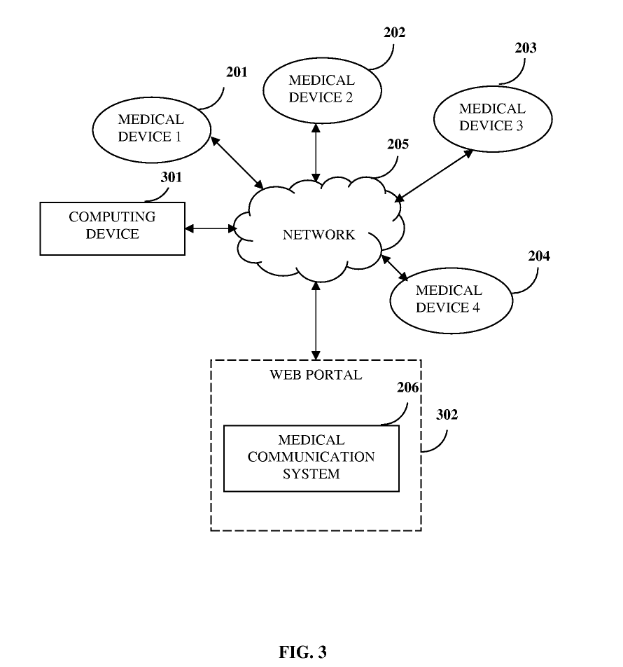

FIG. 3 exemplarily illustrates a system for controlling medical electronic devices using a web portal 302. The web portal 302 comprises the medical communication system 206. The system disclosed herein comprises multiple medical electronic devices, for example, medical device 1 201, medical device 2 202, medical device 3 203, and medical device 4 204. The medical electronic devices, a patient, and a doctor are linked via a network 205. The concerned doctor and the patient may not be located at the same location. The concerned doctor accesses the medical electronic devices via the web portal 302. The web portal 302 serves as a single point of access to the medical electronic devices. The web portal 302 may be a web based user interface on the computing devices of doctors, physicians, or caretakers and enables the doctors, physicians, or caretakers to monitor the status of a patient and control medical electronic devices accordingly. The doctors, physicians, or caretakers may also access the captured medical data stored in the medical communication system 206 using the web portal 302. The captured medical data may be accessible to the concerned doctor on a computing device 301, for example, a computer, a laptop, a personal digital assistant (PDA), a mobile phone, etc. The medical data is accessed via the web portal 302. The doctor, physician, or a caretaker may also communicate the captured medical data to other doctors, physicians, or caretakers involved in a particular medical case through the web portal 302.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of integrating and controlling a plurality of medical electronic devices comprising the steps of:
providing a medical communication system for communicating with and controlling said medical electronic devices;
establishing a communication link between said medical communication system and the medical electronic devices;
setting configuration parameters for the medical electronic devices;
configuring the medical electronic devices by the medical communication system via said communication link based on said configuration parameters;
capturing medical data by said configured medical electronic devices;
transferring said captured medical data to the medical communication system via the communication link; and
storing said transferred medical data for medical diagnosis;
whereby the medical communication system integrates and controls the medical electronic devices.

2. The method of claim 1, wherein the medical electronic devices comprise one or more of diagnostic devices, therapeutic devices, life support devices, medical laboratory devices, and medical monitoring devices.

3. The method of claim 1, wherein said step of capturing said medical data is initiated by one of a timer based trigger, an event based trigger, and a combination thereof.

4. The method of claim 3, wherein said event based trigger initiates capturing of the medical data on occurrence of an external medical event.

5. The method of claim 3, wherein said timer based trigger initiates capturing of the medical data by the medical electronic devices based on predefined time settings.

6. The method of claim 1, wherein the transferred medical data is converted into one of a text file, a video file, and an image file by the medical communication system.

7. The method of claim 1, wherein the communication link is one of a wired and a wireless link.

8. The method of claim 1, wherein the configuration parameters comprise device settings and control parameters of the medical electronic devices.

9. The method of claim 1, further comprising a step of configuring the medical electronic devices to a preset mode, wherein the configuration parameters for said preset mode of the medical electronic devices is stored in the medical communication system.

10. The method of claim 1, further comprising a step of scheduling time and sequence of capture of the medical data by the medical electronic devices.

11. The method of claim 1, further comprising a step of analyzing the transferred medical data to automatically generate recommendations on medical procedures to be performed in medical cases by one of a doctor, a physician, and a caretaker.

12. The method of claim 11, further comprising a step of generating a medical report based on said analysis of the transferred medical data, wherein said medical report comprises said recommendations on said medical procedures to be performed in said medical cases by one of said doctor, said physician, and said caretaker.

13. The method of claim 12, further comprising a step of comparing a medical report generated by one of the doctor, the physician, and the caretaker based on a medical diagnosis with the medical report generated by the medical communication system.

14. The method of claim 1, wherein the medical communication system sends a notification to one of a doctor, a physician, and a caretaker.

15. The method of claim 14, wherein said notification comprises alerts for extreme medical conditions, availability of the medical data, and a generated medical report.

16. A system for integrating and controlling a plurality of medical electronic devices comprising:
a medical communication system for communicating with and controlling said medical electronic devices;
a device selection module for selecting at least one of the medical electronic devices to capture medical data;
a communication module for establishing a communication link between said medical communication system and said selected medical electronic devices;
a parameter configuration module for configuring the selected medical electronic devices using a set of configuration parameters via said communication link, wherein said configuration parameters comprise
device settings and control parameters of the medical electronic devices; and
a medical data capture module for capturing said medical data transferred from said configured medical electronic devices.

17. The system of claim 16, wherein said medical communication system further comprises a graphical user interface for performing the steps of:
viewing said medical data captured by one or more of the medical electronic devices; and
altering the configuration parameters of one or more of the medical electronic devices.

18. The system of claim 16, wherein the medical communication system further comprises a scheduler for scheduling time and sequence of capture of the medical data by the medical electronic devices.

19. The system of claim 16, wherein the medical communication system further comprises an intelligent data analyzer for analyzing said captured medical data to automatically generate recommendations on medical procedures to be performed in medical cases by one of a doctor, a physician, and a caretaker.

20. The system of claim 19, wherein the medical communication system further comprises a report generation module for generating a medical report based on said analysis of the captured medical data, wherein said medical report comprises said recommendations on said medical procedures to be performed in said medical cases by one of said doctor, said physician, and said caretaker.

21. The system of claim 20, wherein the medical communication system further comprises a report comparison module for comparing the medical report generated by the medical communication system with a medical report generated by one of a doctor, a physician, and a caretaker.

22. The system of claim 16, further comprising a web portal for remotely controlling the medical electronic devices by a doctor, a physician, and a caretaker.

23. The system of claim 16, wherein the medical communication system further comprises a notification module for sending a notification to one of a doctor, a physician, and a caretaker, wherein said notification comprises alerts for extreme medical conditions, availability of the medical data, and a generated medical report.

24. The system of claim 16, wherein the medical communication system further comprises a data storage module for storing said transferred medical data for medical diagnosis, configuration parameter settings of the medical electronic devices, said captured medical data, and scheduling information comprising information on time and sequence of capture of the medical data by the medical electronic devices.

25. A computer program product comprising computer executable instructions embodied in a computer-readable medium, wherein said computer program product comprises:
a first computer parsable program code for establishing a communication link between a medical communication system and medical electronic devices;
a second computer parsable program code for setting configuration parameters for said medical electronic devices;
a third computer parsable program code for configuring the medical electronic devices by said medical communication system via said communication link based on said configuration parameters;
a fourth computer parsable program code for capturing medical data by said configured medical electronic devices;
a fifth computer parsable program code for transferring said captured medical data to the medical communication system via the communication link; and
a sixth computer parsable program code for storing said transferred medical data for medical diagnosis.
